(19) United States
(12) Patent Application Publication
(10) Pub. No.: US 2026/0205259 A1
(43) Pub. Date: Jul. 16, 2026

(54) HOMOMORPHIC OPERATION APPARATUS, HOMOMORPHIC OPERATION METHOD, AND HOMOMORPHIC OPERATION PROGRAM

(71) Applicant: NEC Corporation, Tokyo (JP)

(72) Inventors: Yukimasa SUGIZAKI, Tokyo (JP); Naoya ITO, Tokyo (JP); Hikaru TSUCHIDA, Tokyo (JP)

(73) Assignee: NEC Corporation, Tokyo (JP)

(21) Appl. No.: 19/136,974

(22) PCT Filed: Dec. 13, 2022
(86) PCT No.: PCT/JP2022/045938

§ 371 Date: Jun. 9, 2025

(51) Int. Cl. H04L 9/00

(52) U.S. Cl. CPC H04L 9/008

(57) ABSTRACT

A homomorphic operation apparatus executes a homomorphic operation on a ciphertext of a plaintext, the ciphertext having been obtained by homomorphic encryption, without decrypting the ciphertext. The homomorphic operation apparatus includes: an operation key storage part that stores an operation key for executing the homomorphic operation without decrypting the ciphertext; a logic gate operation part that executes a logic gate homomorphic operation on the ciphertext of the plaintext by using the operation key; and a 3-input adder part that is constituted by replacing the logic gates included in an adder circuit which is constituted by connecting full adders in series with the homomorphic operation executed by the logic gate operation part, which receives two encrypted values and one 1-bit value.

### TECHNICAL FIELD

The present invention relates to a homomorphic operation apparatus, a homomorphic operation method, and a homomorphic operation program.

### BACKGROUND ART

There is an encryption technique referred to as “homomorphic encryption”. When ciphertexts Enc(m₁) and Enc(m₂) of plaintexts m₁ and m₂ are given, the homomorphic encryption enables calculation of a ciphertext Enc(m₁◯m₂) of a binary operation m₁◯m₂ of the plaintexts m₁ and m₂, without decrypting the ciphertexts Enc(m₁) and Enc(m₂) to the plaintexts m₁ and m₂. The above “◯” represents a binary operation such as addition “+” or multiplication “x”. The homomorphic encryption regarding addition “+” is referred to as “additive homomorphic encryption”. The homomorphic encryption having homomorphism regarding not only addition “+” but also multiplication “x” is referred to as “fully homomorphic encryption”.

Since the fully homomorphic encryption has homomorphism regarding both addition and multiplication, the fully homomorphic encryption has the best property. However, the processing load of a homomorphic operation of the fully homomorphic encryption is much heavier than that needed for a plaintext operation, and the ciphertext size is very large. For example, in the case of TFHE disclosed in NPL1, the time needed for XOR and AND operations are about ten million times that of a plaintext operation, and the size of a ciphertext of a 1-bit plaintext needs about 105 bits. Thus, when a function operation is executed by using the fully homomorphic encryption, some efforts need to be made, such as expressing the calculation target function by using a logic circuit with fewer logic gates, and reducing the bit number of intermediate values to be held.

Secure summation that receives a sequence of values encrypted by using the fully homomorphic encryption and that calculates the sum of the values is widely used in secure statistical processing (mean, variance, etc.), secure inner product calculation, etc. Binary adder tree (BAT) is known as a technique to reduce the number of additions in this secure summation (see NPL2, for example).

### CITATION LIST

### Non-Patent Literature

NPL1: Chillotti et al., “Faster Fully Homomorphic Encryption: Bootstrapping in Less Than 0.1 Seconds”, ASIACRYPT 2016
NPL2: Fu et al., “GateNet: Bridging the Gap Between Binarized Neural Network and FHE Evaluation”, ICLR2021 Workshop

### SUMMARY

### Technical Problem

The disclosure of each of the above-described NPLs is incorporated herein by reference thereto, and the following analysis has been made by the present inventors.

BAT has redundancy in the number of additions and the number of intermediate values to be held during the calculation, thereby increasing the execution time and the data size. This is a significant weak point for the fully homomorphic encryption of which the operation processing load and the ciphertext size are larger than those of a plaintext operation. Therefore, there is a demand for a technique that needs fewer additions and less processing load in homomorphic operation than those of BAT

In view of the above-described problem, an object of the present invention is to provide a homomorphic operation apparatus, homomorphic operation method, and a homomorphic operation program that contribute to reduction in the number of additions and the processing load in homomorphic operation.

### Solution to Problem

According to a first aspect of the present invention, there is provided a homomorphic operation apparatus that executes a homomorphic operation on a ciphertext of a plaintext, the ciphertext having been obtained by homomorphic encryption, without decrypting the ciphertext, the homomorphic operation apparatus including: an operation key storage part that stores an operation key for executing the homomorphic operation without decrypting the ciphertext; a logic gate operation part that executes a logic gate homomorphic operation on the ciphertext of the plaintext by using the operation key; and a 3-input adder part that is constituted by replacing logic gates included in an adder circuit which is constituted by connecting full adders in series with the homomorphic operation executed by the logic gate operation part, which receives two encrypted values and one 1-bit value.

According to a second aspect of the present invention, there is provided a homomorphic operation method, executed by a homomorphic operation apparatus that executes a homomorphic operation on a ciphertext of a plaintext, the ciphertext having been obtained by homomorphic encryption, without decrypting the ciphertext, the homomorphic operation method including: receiving two encrypted values and one 1-bit value and executing a series of processes constituted by replacing logic gates included in an adder circuit which is constituted by connecting full adders in series with a homomorphic operation.

According to a third aspect of the present invention, there is provided a homomorphic operation program that a executes homomorphic operation on a ciphertext of a plaintext, the ciphertext having been obtained by homomorphic encryption, without decrypting the ciphertext, on an information processing apparatus including a processor and a memory storing a command executed by the processor, the homomorphic operation program including a process of: receiving two encrypted values and one 1-bit value and executing a series of processes constituted by replacing logic gates included in an adder circuit which is constituted by connecting full adders in series with a homomorphic operation.

This program can be recorded in a computer-readable storage medium. The storage medium may be a non-transitory storage medium such as a semiconductor memory, a hard disk, a magnetic recording medium, or an optical recording medium. The present invention can be embodied as a computer program product.

### Advantageous Effects of Invention

According to the individual aspects of the present invention, there are provided a homomorphic operation apparatus, a homomorphic operation method, and a homomorphic operation program that contribute to reduction in the number of additions and the processing load in homomorphic operation.

### BRIEF DESCRIPTION OF DRAWINGS

FIG. 1 is a conceptual diagram illustrating a configuration of a homomorphic operation apparatus according to a first example embodiment according to the present invention.

FIG. 2 is a diagram illustrating redundancy in binary adder tree (BAT).

FIG. 3 is a diagram illustrating a 2-input adder circuit and a 3-input adder circuit.

FIG. 4 is a diagram illustrating a method for replacing a 3-input adder circuit by a homomorphic operation.

FIG. 5 is a conceptual diagram illustrating a configuration of a homomorphic operation apparatus according to a second example embodiment of the present invention.

FIG. 6 is a diagram illustrating an example of summation of a 1-bit sequence according to the second example embodiment.

FIG. 7 is a diagram illustrating an example of summation of the 1-bit sequence by using a conventional BAT.

FIG. 8 is a conceptual diagram illustrating a configuration of a homomorphic operation apparatus according to a third example embodiment of the present invention.

FIG. 9 is a diagram illustrating an example of summation of a multiple-bit value sequence according to the third example embodiment.

FIG. 10 is a diagram illustrating an example of summation of the multiple-bit value sequence by using the conventional BAT.

FIG. 11 is a diagram illustrating a hardware configuration example of a homomorphic operation apparatus.

### EXAMPLE EMBODIMENTS

Hereinafter, example embodiments of the present invention will be described with reference to drawings. However, the present invention is not limited to the following example embodiments. In addition, in the individual drawings, the same or equivalent elements are denoted by the same reference characters, as needed. The drawings are schematical drawings, and it should be noted that the size relationship between elements, the ratio between elements, etc., may differ from the actual relationship, ratio, etc. These size relationship and ratio may differ between different drawings.

### First Example Embodiment

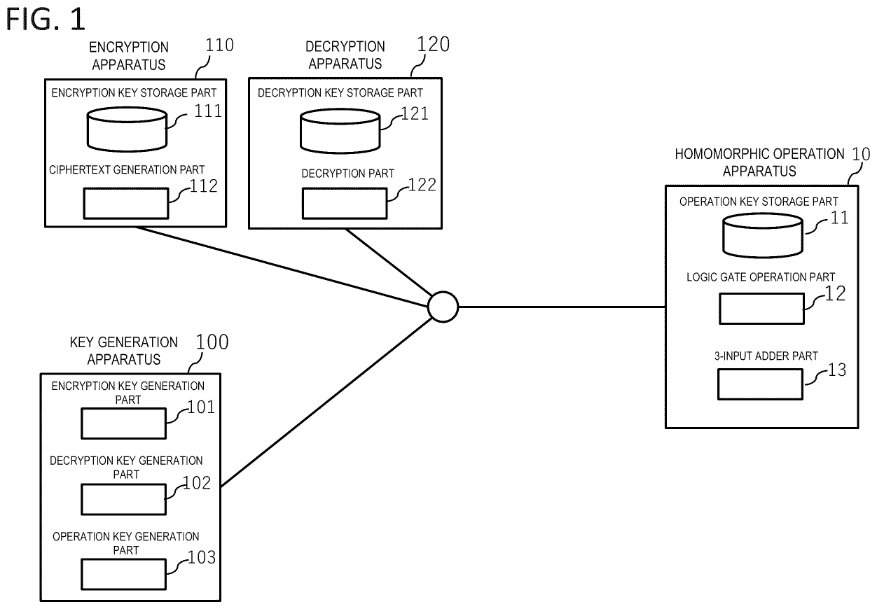

FIG. 1 is a conceptual diagram illustrating a configuration of a homomorphic operation apparatus according to a first example embodiment of the present invention. As illustrated in FIG. 1, a homomorphic operation apparatus 10 includes an operation key storage part 11, a logic gate operation part 12, and a 3-input adder part 13. The homomorphic operation apparatus 10 is an information processing apparatus for executing a homomorphic operation on a ciphertext(s) of a plaintext(s), the ciphertext(s) having been obtained by homomorphic encryption, without decrypting the ciphertext(s). In order to handle the ciphertext(s) obtained by homomorphic encryption, the homomorphic operation apparatus 10 is connected to a key generation apparatus 100, an encryption apparatus 110, and a decryption apparatus 120 such that these apparatuses can communicate with each other.

The key generation apparatus 100 includes an encryption key generation part 101, a decryption key generation part 102, and an operation key generation part 103. The encryption key generation part 101 generates an encryption key for encrypting a plaintext to a ciphertext that complies with homomorphic encryption, and transmits the generated encryption key to the encryption apparatus 110. The decryption key generation part 102 generates a decryption key for decrypting the ciphertext obtained by using the homomorphic encryption to the plaintext, and transmits the generated decryption key to the decryption apparatus 120. The operation key generation part 103 generates an operation key for executing a homomorphic operation on the ciphertext of the plaintext, the ciphertext having been obtained by homomorphic encryption, without decrypting the ciphertext, and for obtaining a post-calculation ciphertext of the plaintext. The operation key generation part 103 transmits the generated operation key to the homomorphic operation apparatus 10.

The encryption apparatus 110 includes an encryption key storage part 111 and an ciphertext generation part 112. The encryption key storage part 111 receives the encryption key generated by the encryption key generation part 101 in the key generation apparatus 100, and stores this encryption key. The ciphertext generation part 112 encrypts a plaintext by using the encryption key stored in the encryption key storage part 111. While the generated ciphertext may be stored in the encryption apparatus 110, the generated ciphertext is transmitted to the decryption apparatus 120 or the homomorphic operation apparatus 10, depending on the use of the ciphertext.

The decryption apparatus 120 includes a decryption key storage part 121 and a decryption part 122. The decryption key storage part 121 receives the decryption key generated by the decryption key generation part 102 in the key generation apparatus 100 and stores this decryption key. The decryption part 122 decrypts a ciphertext by using the decryption key stored in the decryption key storage part 121.

The operation key storage part 11 in the homomorphic operation apparatus 10 receives the operation key generated by the operation key generation part 103 in the key generation apparatus 100 and stores this operation key. The logic gate operation part 12 executes a logic gate homomorphic operation on a ciphertext of a plaintext by using the operation key. The 3-input adder part 13 is an operation module that is constituted by replacing the logic gates included in an adder circuit, which receives two encrypted values and one 1-bit value and which is constituted by connecting full adders in series, by a homomorphic operation executed by the logic gate operation part 12. Hereinafter, functions of the logic gate operation part 12 and the 3-input adder part 13 will be described in more detail.

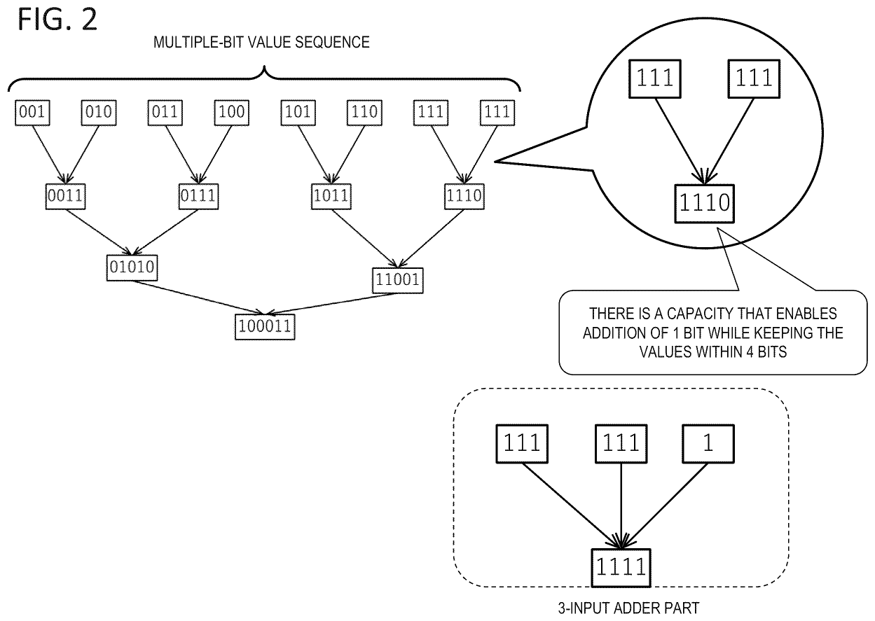

FIG. 2 illustrates redundancy in binary adder tree (BAT). As illustrated in FIG. 2, in BAT, a sequence of multiple-bit input values {001, 010, 011, 100, 101, 110, 111, 111} is divided into pairs. By repeating addition on these pairs, a sum of all the multiple-bit values is finally obtained. By executing the addition in this tree form, it is possible to reduce the number of additions. However, this binary adder tree (BAT) has more capacity than necessary.

For example, in the example of BAT illustrated in FIG. 2, two bit pairs {111, 111} are added. Because the result of the addition of these two bit pairs {111, 111} is {1110}, there is still a capacity that enables addition of 1 bit while keeping the values within 4 bits. Thus, the 3-input adder part 13 adds one 1-bit value to the input of the two encrypted values. That is, by using the above-described capacity, the number of additions can be further reduced.

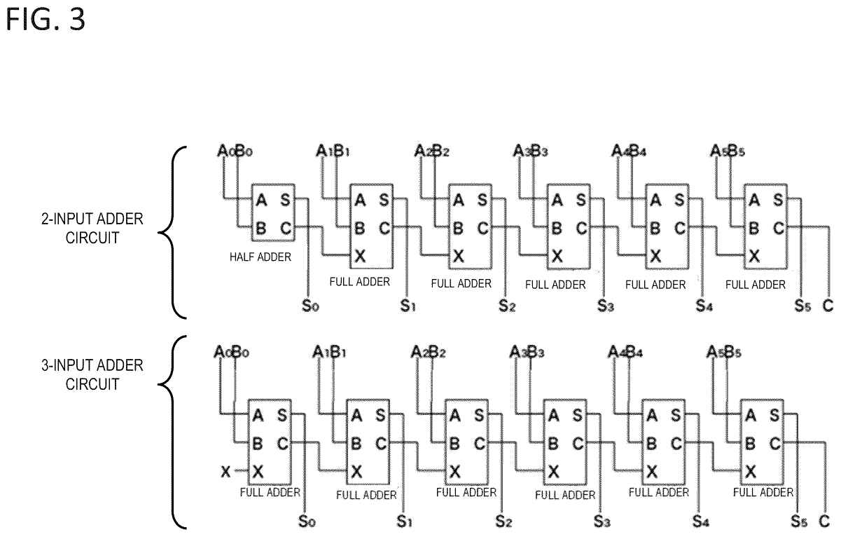

FIG. 3 is a diagram illustrating a 2-input adder circuit and a 3-input adder circuit. As illustrated in FIG. 3, the 2-input adder circuit receives two multiple-bit values {A₅ A₄ A₃ A₂ A₁ A₀, B₅ B₄ B₃ B₂ B₁ B₀}, and outputs an addition result of these two multiple-bit values {C S₅ S₄ S₃ S₂ S₁ S₀}. Because the 2-input adder circuit receives two multiple-bit values, a half adder is used to receive A₀ and B₀. Other than this half adder, full adders connected in series are used to constitute the 2-input adder circuit. The full adders and the half adder each include two output terminals S and C. The individual output terminal S indicates its corresponding addition result, and the individual output terminal C indicates that its corresponding addition result needs a carry to the next digit. This is why a half adder is used to receive A₀ and B₀.

On the other hand, in addition to the two multiple-bit values {A₅ A₄ A₃ A₂ A₁ A₀, B₅ B₄ B₃ B₂ B₁ B₀}, the 3-input adder circuit receives one 1-bit value {X}, and outputs an addition result {C S₅ S₄ S₃ S₂ S₁ S₀} of these three values. In the 2-input adder circuit, a half adder receives A₀ and B₀. However, since the 3-input adder circuit receives the one 1-bit value {X} in addition to A₀ and B₀, a full adder is used in place of the half adder. As described above, the addition result of two bit pairs includes the capacity that enables addition of one bit without increasing the bit number (digit number). Although the 3-input adder circuit receives the one 1-bit value {X} by using a full adder in place of a half adder, the bit number (digit number) of the output result is not increased or an overflow is not caused during the process.

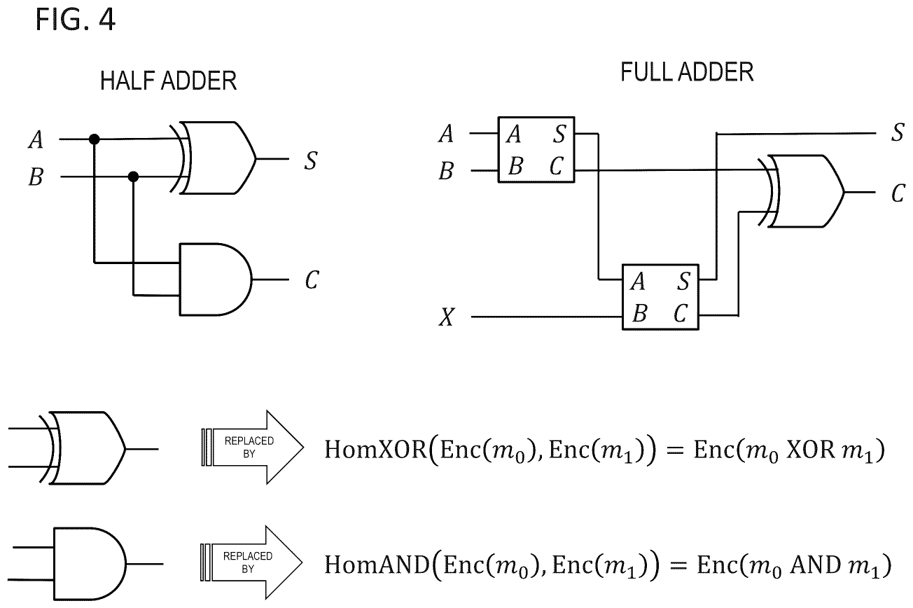

FIG. 4 is a diagram illustrating a method for replacing a 3-input adder circuit by a homomorphic operation. As illustrated in FIG. 4, a half adder and a full adder can be constituted by logical AND (AND) and exclusive OR (XOR) logic gates. A half adder can be constituted by one logical AND (AND) logic gate and one exclusive OR (XOR) logic gate. A full adder can be constituted by two half adders and one exclusive OR (XOR) logic gate, that is, by two logical AND (AND) logic gates and three exclusive OR (XOR) logic gates. A logical operation indicated by logical AND (AND) and exclusive OR (XOR) logic gates can also be realized by a homomorphic operation of homomorphic encryption.

The 3-input adder part 13 according to the first example embodiment can be realized as an operation module that is constituted by replacing the logic gates included in an adder circuit, which is constituted by connecting full adders in series as described above, by a homomorphic operation executed by the logic gate operation part 12. The operation module that is constituted by replacing the logic gates included in the adder circuit, which is constituted by connecting full adders in series, by the homomorphic operation executed by the logic gate operation part 12 may be executed as a series of processes for executing the homomorphic operation, instead of implementing the operation module as hardware.

### Second Example Embodiment

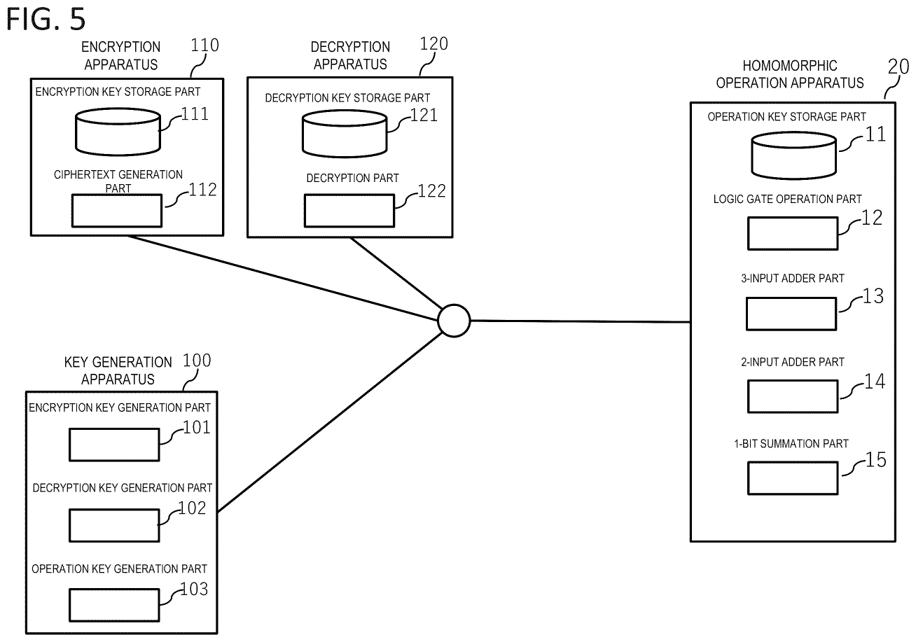

FIG. 5 is a conceptual diagram illustrating a configuration of a homomorphic operation apparatus according to a second example embodiment of the present invention. The homomorphic operation apparatus according to the first example embodiment includes the 3-input adder part 13. However, when three or more 1-bit values need to be added, there could be a situation in which only the 3-input adder part 13 is insufficient. Thus, the homomorphic operation apparatus according to the second example embodiment includes additional components such that the homomorphic operation apparatus can manage the situation in which three or more 1-bit values need to be added.

As illustrated in FIG. 5, a homomorphic operation apparatus 20 includes an operation key storage part 11, a logic gate operation part 12, a 3-input adder part 13, a 2-input adder part 14, and a 1-bit summation part 15. As in the first example embodiment, the homomorphic operation apparatus 20 is an information processing apparatus for executing a homomorphic operation on a ciphertext(s) of a plaintext(s), the ciphertext(s) having been obtained by homomorphic encryption, without decrypting the ciphertext(s). In order to handle the ciphertext(s) obtained by homomorphic encryption, the homomorphic operation apparatus 20 is connected to a key generation apparatus 100, an encryption apparatus 110, and a decryption apparatus 120 such that these apparatuses can communicate with each other. The key generation apparatus 100, the encryption apparatus 110, and the decryption apparatus 120 can be constituted by the same components and functions as those according to the first example embodiment.

The operation key storage part 11, the logic gate operation part 12, and the 3-input adder part 13 in the homomorphic operation apparatus 20 can also be constituted by the same components and functions as those according to the first example embodiment. On the other hand, the 2-input adder part 14 is an operation module that is constituted by replacing the logic gates included in an adder circuit, which receives two encrypted values and which is constituted by connecting a half adder and full adders in series, by a homomorphic operation executed by the logic gate operation part. The 2-input adder part 14 is constituted by replacing the logic gates included in the 2-input adder circuit illustrated in FIG. 3 by a homomorphic operation. As is the case with the 3-input adder part 13, the 2-input adder part 14 may be executed as a series of processes for executing the homomorphic operation, instead of implementing the 2-input adder part 14 as hardware.

In addition, the 1-bit summation part 15 executes summation of a 1-bit sequence by repeating a process of receiving three or more encrypted 1-bit values, dividing the received (input) sequence into a primary sequence and a secondary sequence, selecting two values from the primary sequence or the secondary sequence, entering the selected values to the 2-input adder part 14 or the 3-input adder part 13, selecting one value from the secondary sequence, entering the 1-bit value to the 3-input adder part 13, and adding the output of the 2-input adder part 14 or the 3-input adder part 13 to the primary sequence.

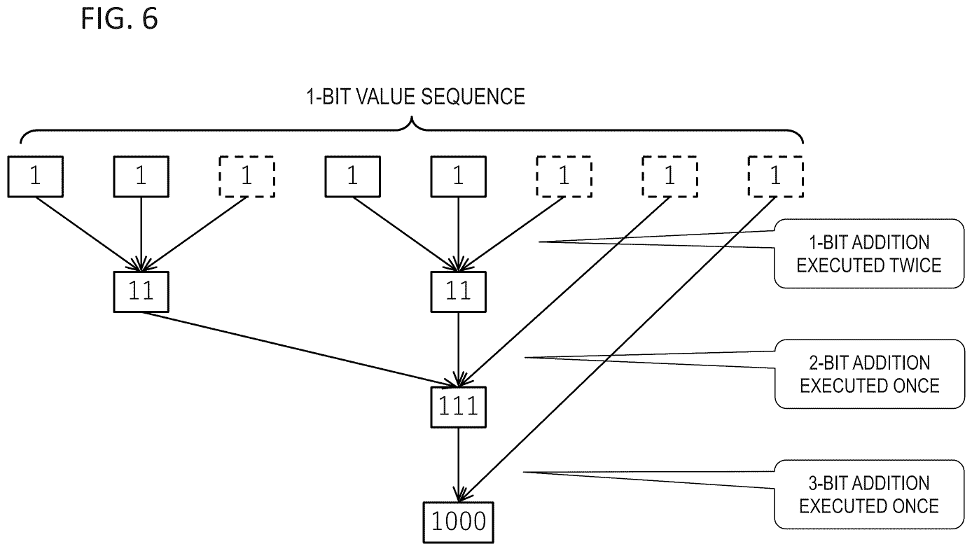

FIG. 6 is a diagram illustrating an example of summation of a 1-bit value sequence according to the second example embodiment. As illustrated in FIG. 6, for example, when eight 1-bit values are used as the input, summation cannot be completed with a single 3-input addition. Thus, the 1-bit summation part 15 divides the input sequence into a primary sequence (solid lines in FIG. 6) and a secondary sequence (dashed lines in FIG. 6), selects two values from the primary sequence or the secondary sequence, enters the values to the 2-input adder part 14 or the 3-input adder part 13, selects one value from the secondary sequence, and enters the 1-bit value to the 3-input adder part 13. In the example in FIG. 6, two values are selected from the primary sequence (solid lines in FIG. 6) and are entered to the 3-input adder part 13. In addition, one value is selected from the secondary sequence (dashed lines in FIG. 6), and the 1-bit value is entered to the 3-input adder part 13. In addition, the output of the 3-input adder part 13 is added to the primary sequence. By repeating this process, the summation of the eight 1-bit values is executed.

In the example of the summation of the 1-bit values illustrated in FIG. 6, the summation of a 1-bit sequence is executed by executing 1-bit 3-input addition twice, 2-bit 3-input addition once, and 3-bit 3-input addition once. In this case, the number of necessary logic gates is 23, and the simultaneously held values are up to 4 bits.

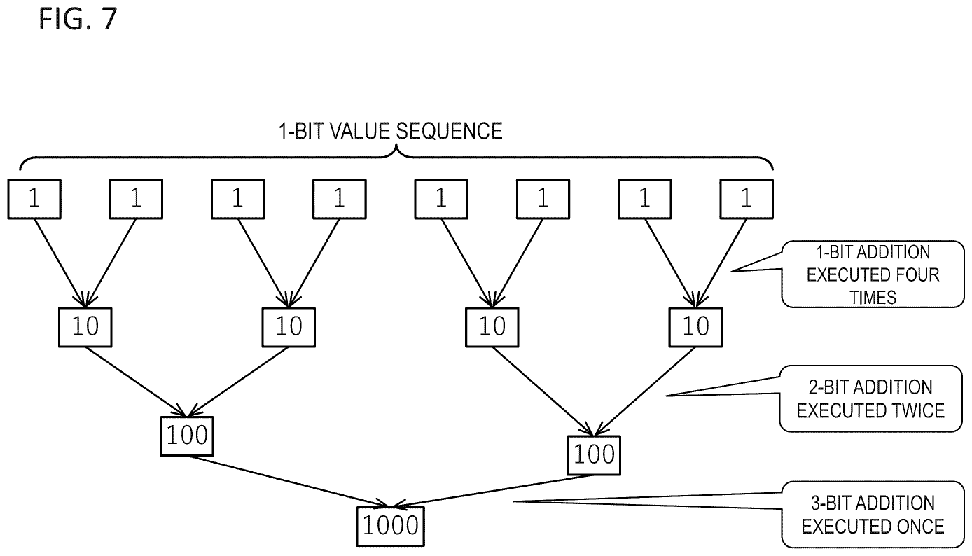

FIG. 7 is a diagram illustrating an example of the summation of a 1-bit sequence by using a conventional BAT. As illustrated in FIG. 7, for example, when eight 1-bit values are used as the input, the summation of a 1-bit sequence is executed by executing 1-bit 2-input addition four times, 2-bit 2-input addition twice, and 3-bit 2-input addition once. In this case, the number of necessary logic gates is 104, and the simultaneously held values are up to 4 bits.

The summation of a 1-bit sequence according to the conventional BAT and the summation of a 1-bit sequence according to the second example embodiment when eight 1-bit values were used as the input were compared with each other. The comparison result indicates that the second example embodiment can reduce the number of necessary logic gates by 11 (32%) and can reduce the simultaneously held values by two bits (33%).

### Third Example Embodiment

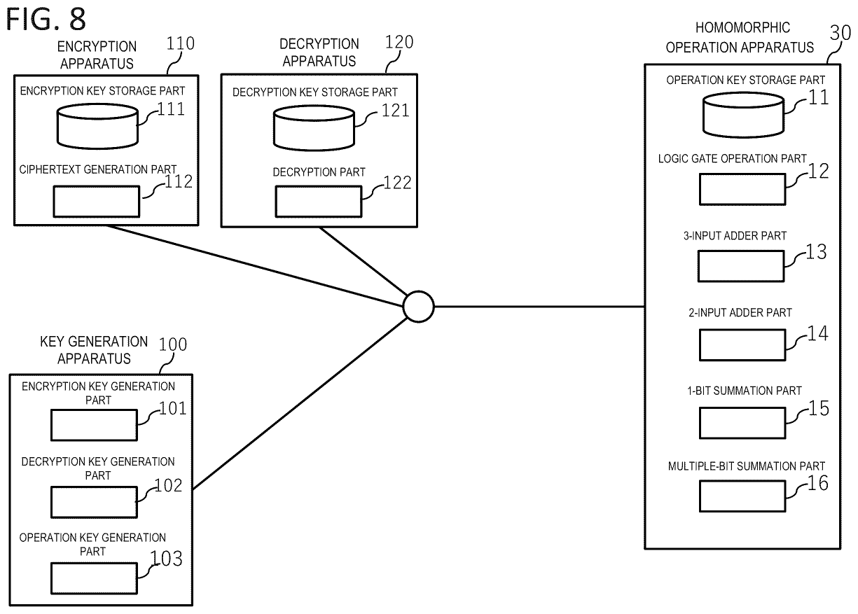

FIG. 8 is a conceptual diagram illustrating a configuration of a homomorphic operation apparatus according to a third example embodiment of the present invention. Although the homomorphic operation apparatus according to the second example embodiment can manage the case in which three or more 1-bit values need to be added, the homomorphic operation apparatus cannot manage a case in which the input values that need to be added are multiple-bit values. To solve this, the homomorphic operation apparatus according to the third example embodiment includes an additional component such that the homomorphic operation apparatus can manage the case in which the input values that need to be added are multiple-bit values.

As illustrated in FIG. 8, a homomorphic operation apparatus 30 includes an operation key storage part 11, a logic gate operation part 12, a 3-input adder part 13, a 2-input adder part 14, a 1-bit summation part 15, and a multiple-bit summation part 16. As in the first example embodiment, the homomorphic operation apparatus 30 is an information processing apparatus for executing a homomorphic operation on a ciphertext(s) of a plaintext(s), the ciphertext(s) having been obtained by homomorphic encryption, without decrypting the ciphertext(s). In order to handle the ciphertext(s) obtained by homomorphic encryption, the homomorphic operation apparatus 30 is connected to a key generation apparatus 100, an encryption apparatus 110, and a decryption apparatus 120 such that these apparatuses can communicate with each other. The key generation apparatus 100, the encryption apparatus 110, and the decryption apparatus 120 can be constituted by the same components and functions as those according to the first example embodiment.

The operation key storage part 11, the logic gate operation part 12, the 3-input adder part 13, the 2-input adder part 14, and the 1-bit summation part 15 in the homomorphic operation apparatus 30 can also be constituted by the same components and functions as those according to the second example embodiment. The multiple-bit summation part 16 executes summation of a multiple-bit value sequence by receiving three or more encrypted multiple-bit values, dividing the multiple-bit values per bit, calculating a sum per divided bit by using the 1-bit summation part, shifting the sum calculated per bit to left depending on the location of the digit of a corresponding divided bit, and calculating a total of the sums of the individual bits by using the 2-input adder part.

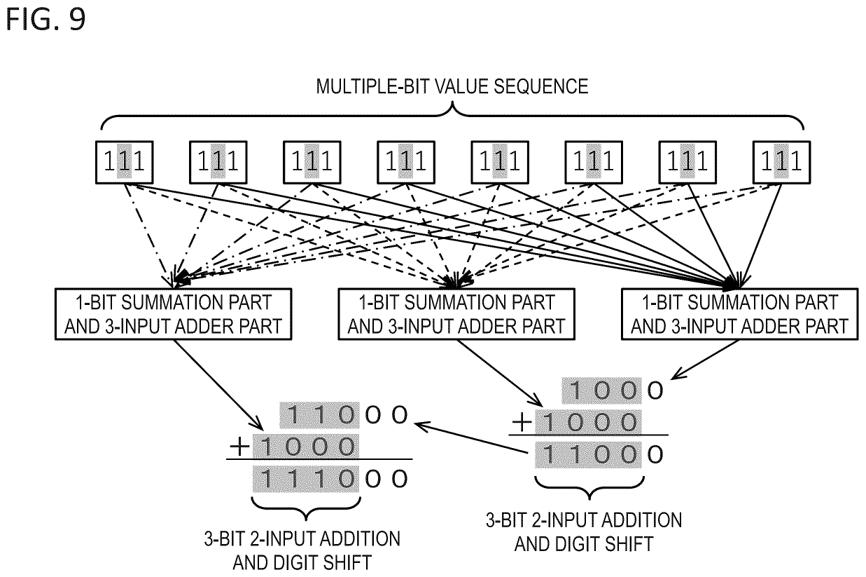

FIG. 9 is a diagram illustrating an example of summation of a multiple-bit value sequence according to the third example embodiment. As illustrated in FIG. 9, for example, when eight 3-bit values are used as the input, the multiple-bit summation part 16 executes the summation by dividing the eight 3-bit values per bit, and calculates a sum per divided bit by using the 1-bit summation part 15 (and the 3-input adder part 13). Next, the multiple-bit summation part 16 shifts the sum calculated per bit to the left depending on the location of the digit of a corresponding divided bit, and calculates a total of the sums of the individual digits by using the 2-input adder part 14.

In the example of the summation of multiple-bit values illustrated in FIG. 9, the number of necessary logic gates is 97, and the simultaneously held values are up to 9 bits.

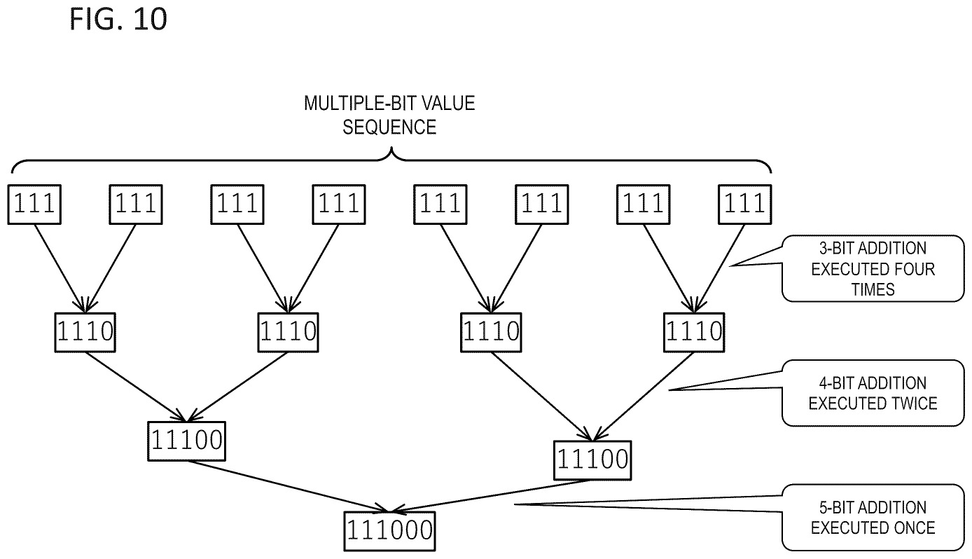

FIG. 10 is a diagram illustrating an example of the summation of multiple-bit values by using the conventional BAT. As illustrated in FIG. 10, for example, when eight 3-bit values are used as the input, the conventional BAT executes the summation of the multiple-bit value sequence by executing 3-bit 2-input addition four times, 4-bit 2-input addition twice, and 5-bit 2-input addition once. In this case, the number of necessary logic gates is 104, and the simultaneously held values are up to 10 bits.

The summation of the multiple-bit value sequence according to the conventional BAT and the summation of the multiple-bit value sequence according to the third example embodiment when eight 3-bit values were used as the input were compared with each other. The comparison result indicates that the third example embodiment can reduce the number of necessary logic gates by 7 (7%) and can reduce the simultaneously held values by 1 bit (10%).

### [Comparison in Calculation Time]

Next, the comparison result between the calculation time of the summation of 1-bit values by using the conventional BAT and the calculation time of the summation of 1-bit values according to the second example embodiment will be described as verification of effects of the present invention. The present verification experiment was conducted by using TFHE disclosed in NPL1 as the fully homomorphic encryption. In this threshold fully homomorphic encryption, homomorphic operations of exclusive OR (XOR) and logical AND (AND) can be calculated within almost the same processing time. In addition, https://github.com/ilachill/MK-TFHE was used for the implementation of the program of the threshold fully homomorphic encryption, and CPU: Intel Core i7-7700, memory: DDR4-2400 32 GB, OS: Ubuntu 18.04 were used as the experiment environment.

The summation of 1-bit values and the summation of 1-bit values according to the second example embodiment were executed under the conditions that the number of 1-bit values was 10, 100, and 1000. The necessary calculation time was summarized as follows. The acceleration rate was defined by ((conventional)−(the present invention))+(conventional).

TABLE 1

| | Calculation time | Calculation time | |
|---|---|---|---|
| | (s) of summation | (s) of summation | |
| Number of 1-bit | by conventional | by 2^{nd} example | Acceleration |
| values | BAT | embodiment | rate (%) |
| 10 | 3.27 | 2.53 | 22.6 |
| 100 | 43.8 | 32.8 | 25.1 |
| 1000 | 460 | 345 | 25.0 |

As described above, the summation according to the second example embodiment achieves a better performance than the summation according to the conventional BAT by up to about 25%. As described above, the summation of a 1-bit sequence according to the second example embodiment can reduce the number of necessary logic gates by 11 (23%), and can reduce the simultaneously held values by 2 bits (33%). These reduction effects were also confirmed as the reduction in calculation time by up to about 25%.

### [Hardware Configuration Example]

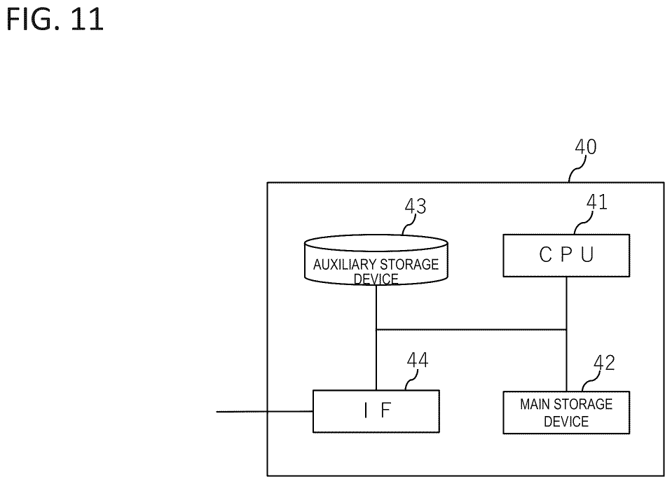

FIG. 11 is a diagram illustrating a hardware configuration example of a homomorphic operation apparatus. An information processing apparatus (a computer) that adopts t the hardware configuration illustrated in FIG. 11 can realize the functions of any one of the homomorphic operation apparatuses 10, 20, and 30 described above. However, the hardware configuration example illustrated in FIG. 11 is an example of the hardware configuration that realizes the functions of any one of the homomorphic operation apparatuses 10, 20, and 30. That is, the hardware configuration of the individual one of the homomorphic operation apparatuses 10, 20, and 30 is not limited to the example illustrated in FIG. 11. The homomorphic operation apparatuses 10, 20, and 30 may include hardware not illustrated in FIG. 11.

As illustrated in FIG. 11, a hardware configuration 40 that can be adopted by any one of the homomorphic operation apparatuses 10, 20, and 30 includes a CPU (Central Processing Unit) 41, a main storage device 42, an auxiliary storage device 43, and an IF (Interface) part 44, which are mutually connected via an internal bus, for example.

The CPU 41 executes individual commands included in a program executed by the corresponding one of the homomorphic operation apparatuses 10, 20, and 30. The main storage device 42 is, for example, a RAM (Random Access Memory), and temporarily stores, for example, various kinds of programs executed by the corresponding one of the homomorphic operation apparatuses 10, 20, and 30. These programs are processed by the CPU 41.

The auxiliary storage device 43 is, for example, an HDD (Hard Disk Drive) and can store, for example, various kinds of programs executed by the corresponding one of the homomorphic operation apparatuses 10, 20, and 30 in the mid to long term. These various kinds of programs can be provided as a program product recorded in a non-transitory computer-readable storage medium. The auxiliary storage device 43 can be used to store various kinds of programs recorded in the non-transitory computer-readable storage medium in the mid to long term. The IF part 44 provides an interface relating to the communications performed between the homomorphic operation apparatuses 10, 20, and 30 and the key generation apparatus 100.

The information processing apparatus that adopts the hardware configuration 40 as described above can realize the individual functions of any one of the homomorphic operation apparatuses 10, 20, and 30.

Part or all of the above-described example embodiments can also be described as, but not limited to, the following notes.

### [Note 1]

A homomorphic operation apparatus that executes a homomorphic operation on a ciphertext(s) of a plaintext(s), the ciphertext(s) having been obtained by homomorphic encryption, without decrypting the ciphertext(s), the homomorphic operation apparatus including:
an operation key storage part that stores an operation key for executing the homomorphic operation without decrypting the ciphertext(s);
a logic gate operation part that executes a logic gate homomorphic operation on the ciphertext(s) of the plaintext(s) by using the operation key; and
a 3-input adder part that is constituted by replacing logic gates included in an adder circuit which is constituted by connecting full adders in series with the homomorphic operation executed by the logic gate operation part, which receives two encrypted values and one 1-bit value.

### [Note 2]

The homomorphic operation apparatus according to note 1, including:
a 2-input adder part that is constituted by replacing logic gates included in an adder circuit which is constituted by connecting a half adder and full adders in series with the homomorphic operation executed by the logic gate operation part, which receives two encrypted values; and
a 1-bit summation part that executes summation of a 1-bit sequence by repeating a process of receiving three or more encrypted 1-bit values, dividing the received sequence into a primary sequence and a secondary sequence, selecting two values from the primary sequence or the secondary sequence, entering the selected two values to the 2-input adder part or the 3-input adder part, selecting one value from the secondary sequence, entering the selected 1-bit value to the 3-input adder part, and adding an output of the 2-input adder part or the 3-input adder part to the primary sequence.

### [Note 3]

The homomorphic operation apparatus according to note 2, including; a multiple-bit summation part that executes summation of a multiple-bit value sequence by receiving three or more encrypted multiple-bit values, dividing the multiple-bit values per bit, calculating a sum per divided bit by using the 1-bit summation part, shifting the sum calculated per bit to left depending on a location of a digit of a corresponding divided bit, and calculating a total of the sums of the individual bits by using the 2-input adder part.

### [Note 4]

A homomorphic operation method, executed by a homomorphic operation apparatus that executes a homomorphic operation on a ciphertext(s) of a plaintext(s), the ciphertext(s) having been obtained by homomorphic encryption, without decrypting the ciphertext(s), the homomorphic operation method including:
receiving two encrypted values and one 1-bit value and executing a series of processes constituted by replacing logic gates included in an adder circuit which is constituted by connecting full adders in series with a homomorphic operation.

### [Note 5]

The homomorphic operation method according to note 4;
wherein the homomorphic operation apparatus includes: a 3-input adder part that is constituted by replacing logic gates included in an adder circuit which is constituted by connecting full adders in series, by a homomorphic operation executed by a logic gate operation part, which receives two encrypted values and one 1-bit value; and a 2-input adder part that is constituted by replacing logic gates included in an adder circuit which is constituted by connecting a half adder and full adders in series with a homomorphic operation executed by the logic gate operation part, which receives two encrypted values; and
wherein the homomorphic operation method includes executing summation of a 1-bit sequence by repeating a process of receiving three or more encrypted 1-bit values, dividing the received sequence into a primary sequence and a secondary sequence, selecting two values from the primary sequence or the secondary sequence, entering the selected two values to the 2-input adder part or the 3-input adder part, selecting one value from the secondary sequence, entering the selected 1-bit value to the 3-input adder part, and adding an output of the 2-input adder part or the 3-input adder part to the primary sequence.

### [Note 6]

The homomorphic operation method according to note 5;
wherein the homomorphic operation apparatus includes: a 1-bit summation part that executes summation of a 1-bit sequence by repeating a process of receiving three or more encrypted 1-bit values, dividing the received sequence into a primary sequence and a secondary sequence, selecting two values from the primary sequence or the secondary sequence, entering the selected two values to the 2-input adder part or the 3-input adder part, selecting one value from the secondary sequence, entering the selected 1-bit value to the 3-input adder part, and adding an output of the 2-input adder part or the 3-input adder part to the primary sequence;
wherein the homomorphic operation method includes executing summation of a multiple-bit value sequence by receiving three or more encrypted multiple-bit values, dividing the multiple-bit values per bit, calculating a sum per divided bit by using the 1-bit summation part, shifting the sum calculated per bit to left depending on a location of a digit of a corresponding divided bit, and calculating a total of the sums of the individual bits by using the 2-input adder part.

### [Note 7]

A homomorphic operation program that executes a homomorphic operation on a ciphertext(s) of a plaintext(s), the ciphertext(s) having been obtained by homomorphic encryption, without decrypting the ciphertext(s), on an information processing apparatus including a processor and a memory storing a command(s) executed by the processor, the homomorphic operation program including a process of:
receiving two encrypted values and one 1-bit value and executing a series of processes constituted by replacing logic gates included in an adder circuit, which is constituted by connecting full adders in series, by a homomorphic operation.

### [Note 8]

The homomorphic operation program according to note 7;
wherein the information processing apparatus includes:
a 3-input adder part that is constituted by replacing logic gates included in an adder circuit which is constituted by connecting full adders in series with a homomorphic operation executed by a logic gate operation part, which receives two encrypted values and one 1-bit value; and
a 2-input adder part that is constituted by replacing logic gates included in an adder circuit which is constituted by connecting a half adder and full adders in series, with a homomorphic operation executed by the logic gate operation part, which receives two encrypted values;
wherein the homomorphic operation program executes summation of a 1-bit sequence by repeating a process of receiving three or more encrypted 1-bit values, dividing the received sequence into a primary sequence and a secondary sequence, selecting two values from the primary sequence or the secondary sequence, entering the selected two values to the 2-input adder part or the 3-input adder part, selecting one value from the secondary sequence, entering the selected 1-bit value to the 3-input adder part, and adding an output of the 2-input adder part or the 3-input adder part to the primary sequence.

### [Note 9]

The homomorphic operation program according to note 8;
wherein the information processing apparatus includes: a 1-bit summation part that executes summation of a 1-bit sequence by repeating a process of receiving three or more encrypted 1-bit values, dividing the received sequence into a primary sequence and a secondary sequence, selecting two values from the primary sequence or the secondary sequence, entering the selected two values to the 2-input adder part or the 3-input adder part, selecting one value from the secondary sequence, entering the selected 1-bit value to the 3-input adder part, and adding an output of the 2-input adder part or the 3-input adder part to the primary sequence;
wherein the homomorphic operation program executes summation of a multiple-bit value sequence by receiving three or more encrypted multiple-bit values, dividing the multiple-bit values per bit, calculating a sum per divided bit by using the 1-bit summation part, shifting the sum calculated per bit to left depending on a location of a digit of a corresponding divided bit, and calculating a total of the sums of the individual bits by using the 2-input adder part.

In the present invention, if an algorithm, software, a flowchart, or an automated process step is indicated, it is obvious that a computer is used. It is also obvious that the computer is provided with a processor and a memory or a storage device. Thus, even if these elements are not explicitly described, it shall be understood that these elements have, of course, been described in the present application.

The disclosure of the above NPLs, etc., which have been referred to, is incorporated herein by reference thereto. Modifications and adjustments of the example embodiments and examples are possible within the scope of the overall disclosure (including the claims) of the present invention and based on the basic technical idea of the present invention. Various combinations and selections (including partial deletions) of various disclosed elements (including the elements in each of the claims, example embodiments, examples, drawings, etc.) are possible within the scope of the overall disclosure of the present invention. That is, the present invention, of course, includes various variations and modifications that could be made by those skilled in the art according to the overall disclosure including the claims and the technical idea. The specification discloses numerical value ranges. However, even if the specification does not particularly disclose numerical values or small ranges included in the ranges, these values and ranges should be deemed to have been specifically disclosed. In addition, as needed and based on the gist of the present invention, partial or entire use of the individual disclosed matters in the above literatures that have been referred to in combination with what is disclosed in the present application should be deemed to be included in what is disclosed in the present application, as part of the disclosure of the present invention.

### REFERENCE SIGNS LIST

10,20,30 homomorphic operation apparatus
11 operation key storage part
12 logic gate operation part
13 3-input adder part
14 2-input adder part
15 1-bit summation part
16 multiple-bit summation part
100 key generation apparatus
101 encryption key generation part
102 decryption key generation part
103 operation key generation part
110 encryption apparatus
111 encryption key storage part
112 ciphertext generation part
120 decryption apparatus
121 decryption key storage part
122 decryption part
40 hardware configuration
41 CPU (Central Processing Unit)
42 main storage device
43 auxiliary storage device
44 IF (Interface) part

What is claimed is:

1. A homomorphic operation apparatus that executes a homomorphic operation on a ciphertext of a plaintext, the ciphertext having been obtained by homomorphic encryption, without decrypting the ciphertext, the homomorphic operation apparatus comprising:
an operation key storage part that stores an operation key for executing the homomorphic operation without decrypting the ciphertext;
a logic gate operation part that executes a logic gate homomorphic operation on the ciphertext of the plaintext by using the operation key; and
a 3-input adder part that is constituted by replacing logic gates included in an adder circuit which is constituted by connecting full adders in series with the homomorphic operation executed by the logic gate operation part, which receives two encrypted values and one 1-bit value.

2. The homomorphic operation apparatus according to claim 1, comprising:
a 2-input adder part that is constituted by replacing logic gates included in an adder circuit which is constituted by connecting a half adder and full adders in series with the homomorphic operation executed by the logic gate operation part, which receives two encrypted values; and
a 1-bit summation part that executes summation of a 1-bit sequence by repeating a process of receiving three or more encrypted 1-bit values, dividing the received sequence into a primary sequence and a secondary sequence, selecting two values from the primary sequence or the secondary sequence, entering the selected two values to the 2-input adder part or the 3-input adder part, selecting one value from the secondary sequence, entering the selected 1-bit value to the 3-input adder part, and adding an output of the 2-input adder part or the 3-input adder part to the primary sequence.

3. The homomorphic operation apparatus according to claim 2, comprising; a multiple-bit summation part that executes summation of a multiple-bit value sequence by receiving three or more encrypted multiple-bit values, dividing the multiple-bit values per bit, calculating a sum per divided bit by using the 1-bit summation part, shifting the sum calculated per bit to left depending on a location of a digit of a corresponding divided bit, and calculating a total of the sums of the individual bits by using the 2-input adder part.

4. A homomorphic operation method, executed by a homomorphic operation apparatus that executes a homomorphic operation on a ciphertext of a plaintext, the ciphertext having been obtained by homomorphic encryption, without decrypting the ciphertext, the homomorphic operation method comprising:
receiving two encrypted values and one 1-bit value and executing a series of processes constituted by replacing logic gates included in an adder circuit which is constituted by connecting full adders in series with a homomorphic operation.

5. The homomorphic operation method according to claim 4;
wherein the homomorphic operation apparatus includes:
a 3-input adder part that is constituted by replacing logic gates included in an adder circuit which is constituted by connecting full adders in series by a homomorphic operation executed by a logic gate operation part, which receives two encrypted values and one 1-bit value; and
a 2-input adder part that is constituted by replacing logic gates included in an adder circuit which is constituted by connecting a half adder and full adders in series with a homomorphic operation executed by the logic gate operation part, which receives two encrypted values; and
wherein the homomorphic operation method includes executing summation of a 1-bit sequence by repeating a process of receiving three or more encrypted 1-bit values, dividing the received sequence into a primary sequence and a secondary sequence, selecting two values from the primary sequence or the secondary sequence, entering the selected two values to the 2-input adder part or the 3-input adder part, selecting one value from the secondary sequence, entering the selected 1-bit value to the 3-input adder part, and adding an output of the 2-input adder part or the 3-input adder part to the primary sequence.

6. The homomorphic operation method according to claim 5;
wherein the homomorphic operation apparatus includes: a 1-bit summation part that executes summation of a 1-bit sequence by repeating a process of receiving three or more encrypted 1-bit values, dividing the received sequence into a primary sequence and a secondary sequence, selecting two values from the primary sequence or the secondary sequence, entering the selected two values to the 2-input adder part or the 3-input adder part, selecting one value from the secondary sequence, entering the selected 1-bit value to the 3-input adder part, and adding an output of the 2-input adder part or the 3-input adder part to the primary sequence;
wherein the homomorphic operation method includes executing summation of a multiple-bit value sequence by receiving three or more encrypted multiple-bit values, dividing the multiple-bit values per bit, calculating a sum per divided bit by using the 1-bit summation part, shifting the sum calculated per bit to left depending on a location of a digit of a corresponding divided bit, and calculating a total of the sums of the individual bits by using the 2-input adder part.

7. A non-transitory computer readable medium storing a homomorphic operation program that executes a homomorphic operation on a ciphertext of a plaintext, the ciphertext having been obtained by homomorphic encryption, without decrypting the ciphertext, on an information processing apparatus including a processor and a memory storing a command executed by the processor, the homomorphic operation program comprising a process of:
receiving two encrypted values and one 1-bit value and executing a series of processes constituted by replacing logic gates included in an adder circuit which is constituted by connecting full adders in series with a homomorphic operation.

8. The non-transitory computer readable medium storing the homomorphic operation program according to claim 7;
wherein the information processing apparatus includes:
a 3-input adder part that is constituted by replacing logic gates included in an adder circuit which is constituted by connecting full adders in series with a homomorphic operation executed by a logic gate operation part, which receives two encrypted values and one 1-bit value; and
a 2-input adder part that is constituted by replacing logic gates included in an adder circuit which is constituted by connecting a half adder and full adders in series with a homomorphic operation executed by the logic gate operation part, which receives two encrypted values;
wherein the homomorphic operation program executes summation of a 1-bit sequence by repeating a process of receiving three or more encrypted 1-bit values, dividing the received sequence into a primary sequence and a secondary sequence, selecting two values from the primary sequence or the secondary sequence, entering the selected two values to the 2-input adder part or the 3-input adder part, selecting one value from the secondary sequence, entering the selected 1-bit value to the 3-input adder part, and adding an output of the 2-input adder part or the 3-input adder part to the primary sequence.

9. The non-transitory computer readable medium storing the homomorphic operation program according to claim 8;
wherein the information processing apparatus includes: a 1-bit summation part that executes summation of a 1-bit sequence by repeating a process of receiving three or more encrypted 1-bit values, dividing the received sequence into a primary sequence and a secondary sequence, selecting two values from the primary sequence or the secondary sequence, entering the selected two values to the 2-input adder part or the 3-input adder part, selecting one value from the secondary sequence, entering the selected 1-bit value to the 3-input adder part, and adding an output of the 2-input adder part or the 3-input adder part to the primary sequence;
wherein the homomorphic operation program executes summation of a multiple-bit value sequence by receiving three or more encrypted multiple-bit values, dividing the multiple-bit values per bit, calculating a sum per divided bit by using the 1-bit summation part, shifting the sum calculated per bit to left depending on a location of a digit of a corresponding divided bit, and calculating a total of the sums of the individual bits by using the 2-input adder part.
